(19) United States
(12) Patent Application Publication
(10) Pub. No.: US 2026/0272247 A1
(43) Pub. Date: Sep. 17, 2026

(54) CLEANING ASSEMBLY AND CLEANING APPARATUS HAVING SAME

(71) Applicant: QUFU SINODOD SMART TECHNOLOGY CO., LTD., Jining (CN)

(72) Inventors: Xinzhong GAO, Jining (CN); Lingyu GAO, Jining (CN); Delong JIA, Jining (CN); Jie DENG, Jining (CN)

(73) Assignee: QUFU SINODOD SMART TECHNOLOGY CO., LTD., Jining (CN)

(21) Appl. No.: 19/163,832

(22) PCT Filed: Nov. 8, 2023
(86) PCT No.: PCT/CN2023/130466

§ 371 Date: Sep. 9, 2025

(30) Foreign Application Priority Data
Mar. 11, 2023 (CN) 202310230575.1

(51) Int. Cl. A47L 11/40; B08B 3/04

(52) U.S. Cl. CPC A47L 11/4041; A47L 11/4016; A47L 11/4083; B08B 3/041

(57) ABSTRACT

Provided are a cleaning assembly and a cleaning apparatus having same. The cleaning assembly includes a cleaning member with an inner cylinder portion and an outer cylinder portion, between which a deformation portion is arranged. A deformation zone is on either side of the deformation portion. At least the outer cylinder portion and the deformable portion are flexible and deformable. The outer cylindrical portion has an outer surface, which is configured to be in a continuous surface structure when the outer cylindrical portion is not in contact with the floor and is configured to at least partially come into contact with the floor and to be recessed towards the deformation zone to form a dirt accommodating space having a concave structure when the outer cylindrical portion is pressed on the floor. The dirt accommodating space has an opening, allowing the dirt accommodating space to open towards the floor.

The present application is a National Phase entry of PCT Application No. PCT/CN2023/130466, filed on Nov. 8, 2023, which claims the priority to Chinese Patent application Ser. No. 20/2310230575.1, titled “CLEANING ASSEMBLY AND CLEANING APPARATUS HAVING SAME”, filed on Mar. 11, 2023 with the China National Intellectual Property Administration, which is incorporated herein by reference in its entirety.

### FIELD

The present application relates to the field of intelligent cleaning, and in particular to a cleaning assembly and a cleaning apparatus having same.

### BACKGROUND

A conventional cleaning apparatus is mainly configured to mop or scrub a floor, in which a rolling member is mainly provided to clean the floor. The rolling member may be configured in two structures. A first structure is to provide a rolling cylinder with a fluff layer or sponge layer, and a second structure is to provide a rolling brush with scraper bars or brush strips. Both the rolling cylinder and the rolling brush may be used to clean the floor. The rolling cylinder is configured to clean the floor by absorbing dirty water, which makes the rolling cylinder prone to harboring dirt and grime and difficult to clean thoroughly. Furthermore, the rolling cylinder requires a drying process; otherwise, it is prone to getting moldy and smelly. The rolling brush, due to the presence of the scraper bars or the brush strips, tends to harbor dirt and grime between the scraper bars or the brush strips, as a result of which the rolling brush is difficult to clean thoroughly. It can be seen that, in addition to the above issues, the conventional rolling member also suffers from issues like poor floor cleaning performance, which significantly affects user experiences.

### SUMMARY

The present application aims to address at least one of the issues in the related technology to a certain extent.

Embodiments of the present application are to provide a cleaning assembly and a cleaning apparatus having same, primarily addressing the issues of conventional rolling members that are prone to trapping dirt and grime, making them difficult to clean thoroughly, and having poor floor cleaning performance.

In an embodiment, a cleaning assembly is provided according to the present application, including a cleaning member for contacting a floor to clean the floor. The cleaning member includes an inner cylindrical portion and an outer cylindrical portion. A deformation portion is provided between the inner cylindrical portion and the outer cylindrical portion. A deformation zone is provided on either side of the deformation portion. At least the outer cylindrical portion and the deformation portion are configured to be flexible and deformable. The outer cylindrical portion has an outer surface, which is configured to be in a continuous surface structure when the outer cylindrical portion is not in contact with the floor, and is configured to at least partially come into contact with the floor and to be recessed towards the deformation zone to form a dirt accommodating space having a concave structure when the outer cylindrical portion is pressed on the floor. The dirt accommodating space has an opening, allowing the dirt accommodating space to open towards the floor. The dirt accommodating space is configured to carry and transfer solid matter or a mixture of solid matter and liquid on the floor when the cleaning member is rotated or rolled on the floor.

According to the aforementioned cleaning assembly, when the cleaning member is placed on the floor and is rotated or rolled, a part of the outer cylindrical portion contacting the floor is recessed to form the dirt accommodating space having the concave structure, and a part of the outer cylindrical portion not in contact with the floor is in the continuous surface structure. When the cleaning member is continuously rotated or rolled, the concave structure and the continuous surface structure are alternately formed on at least a part of the outer surface of the outer cylindrical portion.

According to the aforementioned cleaning assembly, a structure for supplying liquid to the cleaning member is provided in such a way that a washing zone is located at the part of the outer cylindrical portion in the continuous surface structure so that liquid in the washing zone cleans the part of the outer cylindrical portion in the continuous surface structure, and is located above the dirt accommodating space so that the liquid flows downward along the part of the outer cylindrical portion in the continuous surface structure into the dirt accommodating space and is then carried and transferred by the dirt accommodating space.

According to the aforementioned cleaning assembly, during the rotational or rolling movement of the cleaning member, a cross-sectional area of the dirt accommodating space is variable with change of pressure on the outer cylindrical portion or size of solid matter on the floor, so that the solid matter of different sizes can be wrapped in the dirt accommodating space for carrying and transferring.

According to the aforementioned cleaning assembly, the outer cylindrical portion is in a form of a cylinder. When the outer cylindrical portion is not in contact with the floor, the outer surface of the outer cylindrical portion is a complete continuous smooth arc surface in the rotating or rolling direction and is a complete continuous smooth surface in an axial direction thereof.

According to the aforementioned cleaning assembly, at least a part of the outer cylindrical portion close to the floor and the deformation portion close to the floor are deformed when the outer cylindrical portion is pressed, so that the part of the outer surface of the outer cylindrical portion is deformed towards the inner cylindrical portion and the deformation zone, and the deformation portion is deformed towards the deformation zone.

According to the aforementioned cleaning assembly, each of the deformation portion and the outer cylindrical portion is elastically restorable so that, when a pressure applied to the outer cylindrical portion is removed, the deformation portion and the part of the outer cylindrical portion that are deformed are restored synchronously, and the dirt accommodating space having the concave structure is deformed into the continuous surface structure.

According to the aforementioned cleaning assembly, the deformation portion includes an inner end portion and an outer end portion. The inner end portion is connected to the inner cylindrical portion, the outer end portion is connected to the outer cylindrical portion, and the deformation portion is configured to space the outer cylindrical portion and the inner cylindrical portion apart from each other.

According to the aforementioned cleaning assembly, there are deformation portions, and the plurality of deformation portions are spaced apart in the rotating or rolling direction. The deformation zone is formed between every two adjacent deformation portions, meaning that deformation zones are spaced apart in the rotating or rolling direction, and each of the plurality of deformation zones is in a hollow or through structure in an axial direction of the cleaning member.

According to the aforementioned cleaning assembly, the rotating or rolling direction of the cleaning member is defined as a direction A, and the deformation portion extends obliquely from the inner end portion to the outer end portion.

According to the aforementioned cleaning assembly, the deformation portion extends in a direction opposite to the direction A from the inner end portion to the outer end portion in a straightly inclined structure or an arcuately inclined structure. The deformation portion is curved in the direction A in case of the deformation portion in the arcuately inclined structure, or is at an angle Q from the inner cylindrical portion opposite to the direction A in case of the deformation portion in the inclined structure, the angle Q being greater than or equal to 30 degrees and less than or equal to 75 degrees.

According to the aforementioned cleaning assembly, deformation portions are deformed in sequence along the rotating or rolling direction and dirt accommodating spaces are formed in sequence when the cleaning member is rotated or rolled on the floor and is subjected to a pressure. The plurality of dirt accommodating spaces are correspondingly recessed towards deformation zones in sequence, to transfer solid matter or the mixture of solid matter and liquid in the rotating or rolling direction.

According to the aforementioned cleaning assembly, a length L of the deformation portion is greater than one-fifth of an outer diameter D1 of the outer cylindrical portion, or the length L of the deformation portion is greater than one-fifth of an outer diameter D2 of the inner cylindrical portion. In one embodiment, a perpendicular distance H of the deformation portion measured between the outer cylindrical portion and the inner cylindrical portion is greater than or equal to 5 mm.

According to the aforementioned cleaning assembly, a minimum spatial distance of the deformation zone between two adjacent deformation portions in the rotating or rolling direction is greater than or equal to twice the perpendicular distance H of the deformation portion measured between the outer cylindrical portion and the inner cylindrical portion.

According to the aforementioned cleaning assembly, a thickness H1 of the outer cylindrical portion is greater than or equal to 0.5 mm and less than or equal to 1.5 mm.

According to the aforementioned cleaning assembly, the thickness H1 of the outer cylindrical portion is greater than or equal to 0.8 mm and less than or equal to 1.2 mm.

According to the aforementioned cleaning assembly, a thickness H2 of the deformation portion is greater than or equal to a thickness H1 of the outer cylindrical portion. In one embodiment, an average thickness H0 of the deformation portion is greater than or equal to the thickness H1 of the outer cylindrical portion. In one embodiment, a thickened portion is provided at a position where the outer surface of the deformation portion defined in view of the rotating or rolling direction intersects an inner surface of the outer cylindrical portion, and a thickness of the thickened portion is greater than the thickness H1 of the outer cylindrical portion and greater than the thickness H2 of the deformation portion. In one embodiment, the concave structure of the dirt accommodating space is provided with thickened portions at both ends in the rotating or rolling direction, and a thickness of each of the thickened portions is greater than a thickness of part of the concave structure of the dirt accommodating space other than the thickened portions.

According to the aforementioned cleaning assembly, a thickness H3 of the inner cylindrical portion is greater than the thickness H2 of the deformation portion, or a deformation amount of the inner cylindrical portion is smaller than that of the outer cylindrical portion and smaller than that of the deformation portion.

According to the aforementioned cleaning assembly, at least the outer cylindrical portion and the deformation portion are formed of a hydrophobic material, so that the outer cylindrical portion and the deformation portion do not absorb liquid. In one embodiment, at least the outer cylindrical portion is made of a uniform mixture of two materials with different hardness, so that at least a part of the outer surface of the outer cylindrical portion has a frosted structure or a granular structure. In one embodiment, at least the outer cylindrical portion is made of a silicone rubber material with the hardness ranging from 35 to 55 Shore A.

A cleaning apparatus is provided, including a machine body and the aforementioned cleaning assembly. The cleaning assembly is detachably mounted in a cleaning chamber of the machine body, and is configured to contact the floor for cleaning when the cleaning assembly is rotated or rolled. The machine body is provided with a liquid supply box and a recycling box. The machine body is further provided with a liquid supply part connected to the liquid supply box, and the liquid supply part is configured to supply liquid to the cleaning member. The machine body is further provided with a recycling part connected to the recycling box, and the recycling part is configured to allow solid matter or a mixture of solid matter and liquid carried and transferred by the dirt accommodating space to flow through and to be collected in the recycling box. The machine body is further provided with a power member, which is configured to provide power to transfer the solid matter or the mixture of solid matter and liquid to the recycling box for collection.

Compared with the conventional technology, the present application presents the following beneficial effects.

According to the cleaning assembly in the present solution, the cleaning member is provided to perform the rotating or rolling movement to clean the floor. During the rotating or rolling movement, the solid matter or the mixture of solid matter and liquid on the floor are transferred, where the solid matter is garbage, and the liquid is clean water or dirty water, whereby effectively improving the floor cleaning effect.

The cleaning member in the present solution is provided with the outer cylindrical portion, the inner cylindrical portion and the deformation portion. When not in contact with the floor, the outer cylindrical portion is in the continuous surface structure, i.e., is configured to have the continuous surface structure. The continuous surface structure is less prone to harboring dirt and grime, and less prone to adhering to or accumulating garbage or dirty water. When contacting the floor, the outer cylindrical portion is deformed to form the dirt accommodating space having the concave structure. The dirt accommodating space is used to accommodate garbage and dirty water for transferring, so that the garbage and dirty water on the floor can be transferred and collected.

When the cleaning member in the present solution performs the rotating or rolling movement to clean the floor, a part of the outer surface of the outer cylindrical portion is continuously switched between the continuous surface structure and the dirt accommodating space having the concave structure. When the outer cylindrical portion contacts the floor, the dirt accommodating space having the concave structure is formed, and garbage and dirty water can be transferred in this case. When the outer cylindrical portion is not in contact with the floor, the continuous surface structure is formed, and the outer cylindrical portion can be effectively washed in this case. By washing the continuous surface structure of the outer cylindrical portion, the issue of harboring dirt and grime on the outer cylindrical portion can be effectively addressed, the outer cylindrical portion can be easily cleaned, and the outer cylindrical portion can effectively improve the floor cleaning effect.

The outer cylindrical portion and the deformation portion in the present solution enables the outer cylindrical portion and the deformation portion to be effectively deformed, so that the dirt accommodating space having the concave structure can be effectively and stably formed when the outer cylindrical portion is in contact with the floor, and the dirt accommodating space can be effectively restored and switched to the continuous surface structure when the outer cylindrical portion is not subjected to a pressure, to effectively improve the effect of washing the outer cylindrical portion clean and effectively improving the effect of the outer cylindrical portion in transferring garbage and dirty water on the floor.

The outer cylindrical portion and the deformation portion in the present solution enable the cross-sectional area of the concave structure of the dirt accommodating space to increase or decrease when the outer cylindrical portion contacts the floor and the dirt accommodating space is formed, allowing the solid matter of different sizes to be wrapped in the dirt accommodating space for carrying and transferring, and it improve the effect of the cleaning member in transferring and processing garbage of different sizes on the floor.

The outer surface of the outer cylindrical portion in the present solution switches between not in contact with the floor and in contact with the floor during the rotating or rolling movement, to continuously switch between a continuous smooth surface and a continuous smooth arc surface formed on the outer cylindrical portion and the dirt accommodating space having the concave structure, effectively improving the cleaning effect of the cleaning member and at the same time improving the cleaning effect of the cleaning member on the floor.

The outer cylindrical portion and the deformation portion in the present solution enables the outer cylindrical portion to be effectively deformed and to switch from the continuous surface structure to the concave structure of the dirt accommodating space, so that the outer cylindrical portion can be effectively deformed, and has a higher flexibility, and the deformation portion can also be effectively deformed and has a better effect of driving the outer cylindrical portion to be deformed synchronously, facilitating the formation of the dirt accommodating space having the concave structure on the outer cylindrical portion.

The thickness and arrangement of the outer cylindrical portion and the deformation portion in the present solution enable the deformation portion to effectively drive the outer cylindrical portion to deform synchronously, so that a part of the outer cylindrical portion can be effectively deformed towards the deformation zone, and the deformation portion can easily guide the deformation, to effectively improve the effect of formation of the dirt accommodating space.

During the rotating or rolling movement, multiple dirt accommodating spaces are formed in sequence on the outer cylindrical portion in the present solution. The dirt accommodating spaces can be formed correspondingly when different parts of the outer cylindrical portion come into contact with the floor, and the part of the outer cylindrical portion that is not in contact with the floor can be restored accordingly to form the continuous surface structure, enabling easier cleaning of the outer cylindrical portion and improving the floor cleaning effect.

In the present solution, a washing zone is provided for a structure for cleaning the outer cylindrical portion. The washing zone is mainly provided at the part of the outer cylindrical portion in the continuous surface structure, so that the cleaned part on the outer cylindrical portion does not harbor dirt and grime, and the complete continuous surface structure facilitates thorough cleaning of the outer cylindrical portion. Furthermore, liquid, i.e., clean water and dirty water, can also flow easily along the continuous surface structure of the outer cylindrical portion to wash the outer cylindrical portion clean, with the dirty water effectively flowing into the dirt accommodating space to be effectively carried and transferred.

The cleaning member in the present solution does not absorb dirty water and garbage, and the weight of the cleaning member itself does not increase during the cleaning of the floor, which can effectively improve the stability of the rotating or rolling movement of the cleaning member. Further, the cleaning member can be dried more easily without being steam-dried or air-dried, and can be dried in a shorter time in natural state and is less prone to getting moldy and smelly.

The inclined structure of the deformation portion in the present solution enables the deformation portion to be deformed easily, and enables the outer cylindrical portion to be deformed easily in an inclined direction when placed on the floor and subjected to a pressure, so that the dirt accommodating space having the concave structure is formed easily on the outer cylindrical portion, which can more effectively ensure that the deformation portion is restored, and improves the effect of the cleaning member in forming the dirt accommodating space to clean the floor.

The arrangements of the cleaning member in the present solution, the continuous surface structure and the dirt accommodating space having the concave structure on the outer cylindrical portion enable the cleaning member to be effectively washed clean and to clean the floor during the rotating or rolling movement, so that no scraper bars, brush strips, fluff layers or sponge layers is needed to be provided on the cleaning member, and the cleaning member can still effectively clean the floor. Furthermore, the cleaning member can be washed clean during the cleaning of the floor, and the user does not need to maintain and wash the cleaning member after completing the floor cleaning, which greatly improves the convenience and usage experience for the users.

### BRIEF DESCRIPTION OF THE DRAWINGS

FIG. 1 is a schematic perspective view of a cleaning assembly;

FIG. 2 is a schematic view of a cleaning assembly;

FIG. 3 is a schematic perspective side view of a cleaning member;

FIG. 4 is a schematic perspective view of a cleaning member;

FIG. 5 is a schematic side view of a cleaning member;

FIG. 6 is a schematic view of a dirt accommodating space formed when a cleaning member is on a floor;

FIG. 7 is a schematic view of a dirt accommodating space formed when a cleaning member is on the floor and is subjected to a pressure;

FIG. 8 is schematic view of an angle formed between a deformation portion and an inner cylinder portion;

FIG. 9 is a schematic structural view of a cleaning zone formed on a continuous surface structure of an outer cylindrical portion when a liquid supply structure is provided;

FIG. 10 is a schematic perspective view of a cleaning assembly mounted on a cleaning apparatus;

FIG. 11 is a schematic view of a cleaning apparatus collecting and transporting solid matter or a mixture of solid and liquid matter from the floor through a cleaning assembly.

Reference numerals in the drawings are as follows:

| | |
|---|---|
| 1 cleaning assembly; | 10 cleaning member; |
| 101 outer cylinder portion; | 1011 cleaning zone; |
| 102 inner cylinder portion; | 103 deformation portion; |
| 1031 inner end portion; | 1032 outer end portion; |
| 104 deformation zone; | 105 dirt accommodating space; |
| 1051 opening; | 2 cleaning apparatus; |
| 201 cleaning chamber. | |

### DETAILED DESCRIPTION OF THE EMBODIMENTS

To facilitate a clear understanding of the embodiments of the present application will be further described below in conjunction with the embodiments.

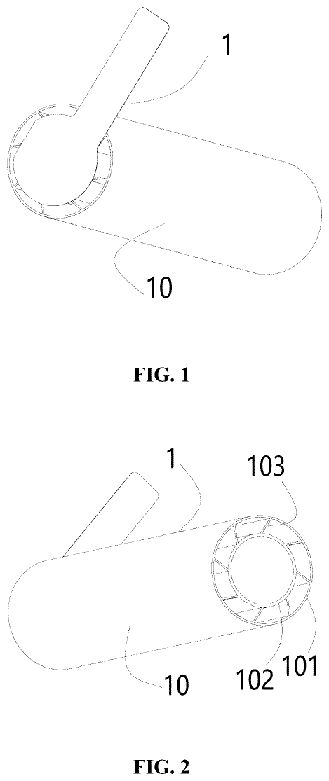

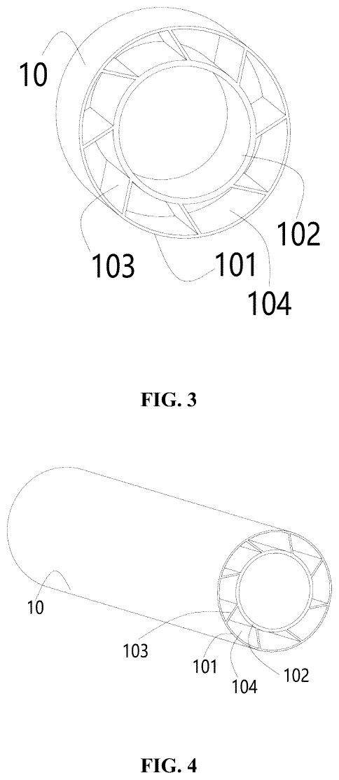

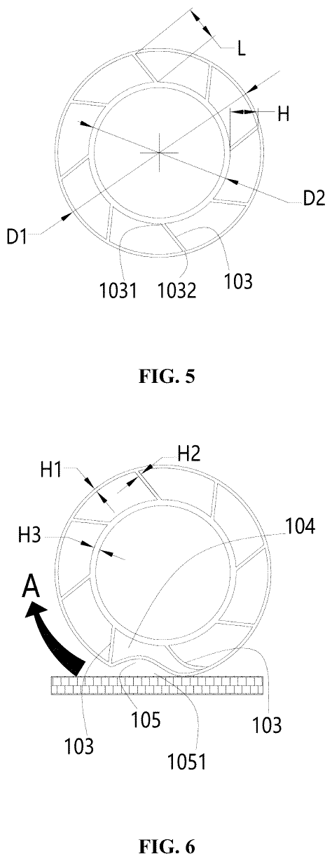

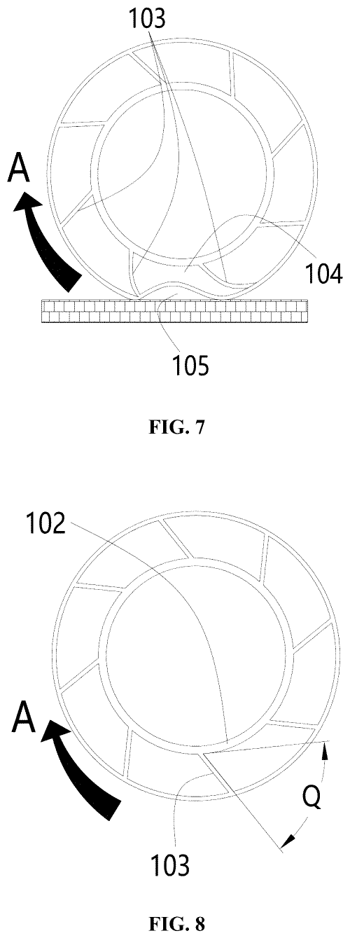

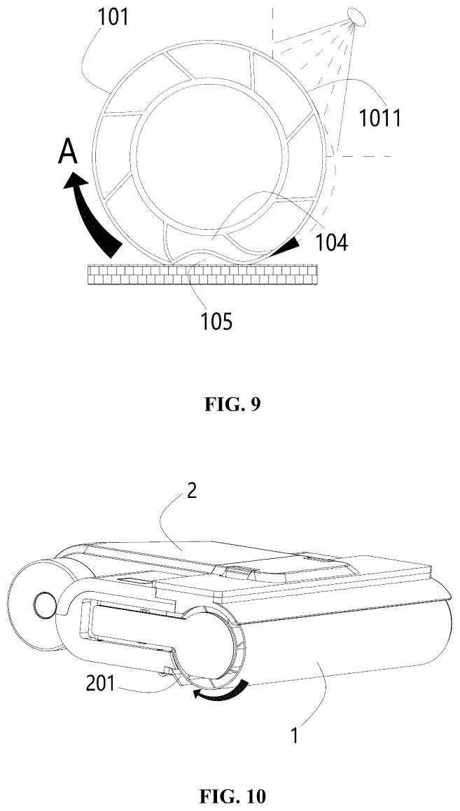

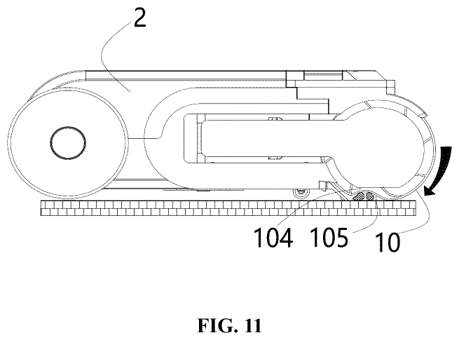

In an embodiment, a cleaning assembly 1 and a cleaning apparatus 2 including the same are provided according to the present application, which are configured as shown in FIGS. 1 to 11. The cleaning assembly 1 is mainly configured to contact a floor for cleaning when being placed on the floor. In one embodiment, the cleaning assembly 1 is mounted on the cleaning apparatus 2, and the cleaning apparatus 2 is activated to enable the cleaning assembly 1 to clean the floor. The structural arrangement and solution of the cleaning assembly 1 addresses the issues in the conventional technology that a rolling member is prone to harboring dirt and grime, making it difficult to clean thoroughly and resulting in a poor floor cleaning performance.

In the present embodiment, the cleaning assembly 1 includes a cleaning member 10 configured to contact the floor for cleaning. The cleaning member 10 is mainly configured to contact the floor and performs a rotating or rolling movement to clean the floor during the contact with the floor. The cleaning member 10 includes an inner cylindrical portion 102 and an outer cylindrical portion 101. The outer cylindrical portion 101 is located outside the inner cylindrical portion 102 or at an outer annular zone of the inner cylindrical portion 102, and the inner cylindrical portion 102 is located inside the outer cylindrical portion 101 or at an inner annular zone of the outer cylindrical portion 101, so that the outer cylindrical portion 101 is arranged to surround the inner cylindrical portion 102. A deformation portion 103 is provided between the inner cylindrical portion 102 and the outer cylindrical portion 101. The deformation portion 103 is configured to be deformable between the outer cylindrical portion 101 and the inner cylindrical portion 102. Further, the deformation portion 103 acts as a supporting structure for the outer cylindrical portion 101. A deformation zone 104 is provided on either side of the deformation portion 103. The deformation zone 104 is provided mainly on either or both sides of the deformation portion 103 in a rotating or rolling direction. The deformation zone 104 is configured to be a hollow or avoidance structure so that the deformation portion 103 may be deformed towards the deformation zone 104. When the cleaning member 10 is placed on the floor for cleaning, an outer surface of the outer cylindrical portion 101 contacts the floor for cleaning, the deformation portion 103 supports the outer cylindrical portion 101, and the inner cylindrical portion 102 drives the outer cylindrical portion 101 and the deformation portion 103 to rotate or roll synchronously.

At least the outer cylindrical portion 101 and the deformation portion 103 are configured to be flexible and deformable structures, so that the outer cylindrical portion 101 and the deformation portion 103 may be deformed. The outer cylindrical portion 101 may be deformed when it comes into contact with the floor. The deformation portion 103 may be deformed along with the deformation of the outer cylindrical portion 101 when the outer cylindrical portion 101 is in contact with the floor and is deformed. The deformations are all directed towards the interior of the deformation zone 104. The floor is cleaned through the deformations of the outer cylindrical portion 101 and the deformation portion 103.

In one embodiment, when the outer cylindrical portion 101 is not in contact with the floor, the outer surface of the outer cylindrical portion 101 is configured to be a continuous surface structure, that is, the outer surface of the outer cylindrical portion 101 is configured to be a complete continuous surface structure, which may also be regarded as a continuous surface structure connected end to end. In this case, since the outer surface is configured to be the continuous surface structure, the outer cylindrical portion 101 is less prone to harboring dirt and grime and can be easily washed clean. When the outer cylindrical portion 101 is on the floor and subjected to a pressure, at least a part of the outer surface of the outer cylindrical portion 101 is in contact with the floor and is recessed towards the deformation zone 104 to form a dirt accommodating space 105 having a concave structure. It can be understood that when the outer surface of the outer cylindrical portion 101 is in contact with the floor and is subjected to a pressure, the part of the outer surface of the outer cylindrical portion 101 contacting the floor is deformed to form the dirt accommodating space 105 having a concave structure. The dirt accommodating space 105 is configured to accommodate garbage and dirty water. When the cleaning member 10 rotates or rolls, the garbage and dirty water in the dirt accommodating space 105 rotate synchronously to be transferred away from the cleaning member 10. The dirt accommodating space 105 has an opening 1051. The dirt accommodating space 105 is opened towards the floor through the opening 1051. The dirt accommodating space 105 has the concave structure mainly towards the inner cylindrical portion 102 and towards the deformation zone 104, and the concave structure is formed with the opening 1051. The opening 1051 communicates the dirt accommodating space 105 with the exterior of the cleaning member 10, that is, communicates the dirt accommodating space 105 with a spatial area on the floor. In this case, the garbage and dirty water on the floor may enter the dirt accommodating space 105 through the opening 1051, so that the garbage and dirty water on the floor can be collected and transferred by the dirt accommodating space 105. That is, the dirt accommodating space 105 is configured to carry and transfers solid matter or a mixture of solid matter and liquid on the floor when the cleaning member 10 rotates or rolls. In this case, the solid matter is the garbage, the liquid is the dirty water, and the mixture of solid matter and liquid is a mixture of the garbage and the dirty water. During the rotating or rolling movement of the cleaning member 10, the dirty water and the garbage on the floor are accommodated and scraped frictionally by the dirt accommodating space 105 having the concave structure formed on the outer cylindrical portion 101, to drive the dirty water and the garbage to move and to be transferred and collected.

Accordingly, the cleaning member 10 in the present embodiment is provided with the outer cylindrical portion 101, the inner cylindrical portion 102 and the deformation portion 103. When the outer cylindrical portion 101 is not in contact with the floor, the outer cylindrical portion 101 has the continuous surface structure, that is, constructed as the continuous surface structure. The continuous surface structure is less prone to harboring dirt and grime, and less prone to adhering to or accumulating garbage or dirty water. When the outer cylindrical portion 101 is in contact with the floor, the outer cylindrical portion 101 is deformed to form the dirt accommodating space 105 having the concave structure. The dirt accommodating space 105 is used to accommodate and transfer the garbage and dirty water, so that the garbage and dirty water on the floor may be transferred and collected. The cleaning member 10 is configured to be easily washed clean, and is less prone to harboring dirt and grime. Also, the dirt accommodating space 105 is configured to significantly improve the floor cleaning effect.

In the present embodiment, the structural parts formed in the cleaning member 10 are provided and when the cleaning member 10 performs the rotating or rolling movement on the floor during the cleaning of the floor, the part of the outer cylindrical portion 101 in contact with the floor is recessed to form the dirt accommodating space 105 having the concave structure, and the part of the outer cylindrical portion 101 not in contact with the floor is in the continuous surface structure. That is, the outer surface of the outer cylindrical portion 101, when not in contact with the floor, has the continuous surface structure, and only when the outer surface of the outer cylindrical portion 101 is in contact with the floor, the part of the outer cylindrical portion 101 in contact with the floor is deformed to form the dirt accommodating space 105, with other parts of the outer surface of the outer cylindrical portion 101 not in contact with the floor remaining the continuous surface structure. During a continuous rotating or rolling movement of the cleaning member 10, at least a part of the outer surface of the outer cylindrical portion 101 is configured to continuously switch between the concave structure and the continuous surface structure. It can be understood that with the rotating or rolling movement of the cleaning member 10, different parts of the outer surface of the outer cylinder part 101 comes into contact with the floor sequentially, and the parts contacting the floor will sequentially move out of contact with the floor. In this way, any part of the outer surface of the outer cylinder part 101 is configured to be continuously switched between the continuous surface structure and the concave structure. The part of the outer surface of the outer cylinder part 101, when configured to be the continuous surface structure, can be easily washed clean. The part of the outer surface of the outer cylinder part 101, when configured to be the concave structure, that is, recessed to form the dirt accommodating space 105, carries and transfers garbage and dirty water. The dirt accommodating space 105 becomes contaminated and dirty during the carrying and transferring of the dirty water and garbage, but may be effectively washed clean when switched to the continuous surface structure. Accordingly, the outer cylindrical portion 101 can always maintain a relatively clean state during the cleaning of the floor. The outer surface of the outer cylindrical portion 101 is less prone to harboring dirt and grime, and will not adhere or absorb a large amount of dirty water or garbage, so that the outer cylindrical portion 101 can be cleaned easily, which in turn allows the outer cylindrical portion 101 to be dried in its natural state.

In the present embodiment, the structural parts for washing the outer cylindrical portion 101 clean are provided and when a structure is provided for supplying liquid, i.e., clean water, to the cleaning member 10, a washing zone 1011 is formed in an area position of the continuous surface structure on the outer cylindrical portion 101. In this case, the area position for washing the outer surface of the outer cylindrical portion 101 is in the continuous surface structure on the outer surface of the outer cylindrical portion 101. In this way, the outer surface of the outer cylindrical portion 101 can be extremely simply and easily washed clean. The washing zone 1011 is less prone to harboring dirt and grime, and less prone to adhering to garbage. Clean water can extremely easily rinse and wash the outer surface of the outer cylindrical portion 101 clean. The above-mentioned structure allows the liquid to wash a part of the continuous surface structure of the outer cylinder part 101 in the washing zone 1011, which greatly improves the effect of washing the outer cylindrical portion 101 clean. Furthermore, the washing zone 1011 is above the dirt accommodating space 105, and the clean water in the washing zone 1011 and the dirty water formed by washing the washing zone 1011 will flow downward along the continuous surface structure. Thus, the liquid will flow downward along the continuous surface structure of the outer cylindrical portion 101 into the dirt accommodating space 105 and be carried and transferred by the dirt accommodating space 105, so that the dirty water generated during washing can effectively flow downward into the dirt accommodating space 105 to be accommodated, making it convenient for the dirt accommodating space 105 to accommodate the dirty water and garbage and then carry and transfer the dirty water and garbage, while generating a floor washing effect, it improve the floor cleaning effect.

In the present embodiment, the structural parts of the cleaning member 10 are provided and during the rotating or rolling movement of the cleaning member 10, the cross-sectional area of the dirt accommodating space 105 is increased or decreased when the pressure on the outer cylindrical portion 101 changes or when there are solid matters of different sizes on the floor, and the dirt accommodating space 105 has a wrapping structure to carry and transfer the solid matters of different sizes. Because the outer cylindrical portion 101 is of a flexible and deformable structure, the recessed depth or the cross-sectional area of the dirt accommodating space 105 changes when the pressure on the outer cylindrical portion 101 changes, or the recessed depth or the cross-sectional area of the dirt accommodating space 105 changes when there are solid matters, i.e. garbage, of different sizes on the floor to contact and press the dirt accommodating space 105. The garbage is in the dirt accommodating space 105 and contacts an outer surface of the dirt accommodating space 105, which has a wrapping structure. With the wrapping structure, the garbage will be carried in the dirt accommodating space 105 to be transferred in the rotating or rolling direction, to transfer and collecting the garbage, while transferring the dirty water.

In one embodiment, when the pressure applied on the outer cylindrical portion 101 increases, the cross-sectional area or the recessed depth of the dirt accommodating space 105 increases. When the pressure applied on the outer cylindrical portion 101 decreases, the cross-sectional area or the recessed depth of the dirt accommodating space 105 decreases. Further, when the volume of garbage on the floor is large, the cross-sectional area or the recessed depth of the dirt accommodating space 105 is large. When the volume of garbage on the floor is small, the cross-sectional area or the recessed depth of the dirt accommodating space 105 is small. In this way, the dirt accommodating space 105 may form a wrapping structure for solid matters of different sizes to better drive and transfer them, which greatly improving the garbage and dirty water transferring effect of the outer cylindrical portion 101, and to improve the floor cleaning effect of the cleaning member 10.

In the present embodiment, the structural parts of the outer cylindrical portion 101 are provided and the outer cylindrical portion 101 is mainly configured to be a columnar structure, a cylindrical structure, or a hollow or through cylindrical structure. The deformation portion 103 is connected to an inner surface of the outer cylindrical portion 101. The deformation portion 103 is provided to be connected to the inner cylindrical portion 102 inside the outer cylindrical portion 101 or at an inner ring of the outer cylindrical portion 101, so that the outer cylindrical portion 101 is located outside the inner cylindrical portion 102 or at outer annular zone of the inner cylindrical portion 102, and the deformation zone 104 with a hollow or through structure is formed between the outer cylindrical portion 101 and the inner cylindrical portion 102. The deformation zone 104 may constitute a part of the outer cylindrical portion 101 to be deformed towards the deformation zone 104. When the outer cylindrical portion 101 is not in contact with the floor, the outer surface of the outer cylindrical portion 101 is provided to be a complete continuous smooth arc surface in the rotating or rolling direction or in a circumferential direction. In this case, the outer surface of the outer cylindrical portion 101 constitutes a complete continuous arc surface or a complete continuous smooth arc surface. It can be understood that, in this case, the outer surface of the outer cylindrical portion 101 is an integral continuous arc surface, there is no dirt accommodating space 105 having the concave structure on the outer surface of the outer cylindrical portion 101, and the outer surface of the outer cylindrical portion 101 is configured in an axial direction thereof to be a complete continuous smooth surface, that is, the structure of the outer surface of the outer cylindrical portion 101 in the direction of a rotation axis is a complete continuous surface structure or a complete continuous smooth surface structure. The outer surface of the outer cylindrical portion 101 is in an integral continuous surface structure in the direction of the rotation axis, and there is no dirt accommodating space 105 having the concave structure. In this case, the outer surface of the outer cylindrical portion 101 can be effectively washed, and clean water flushing on the outer cylindrical portion 101 will flush the continuous surface structure, to extremely simply and easily wash the outer surface of the outer cylindrical portion 101 clean, so that the outer surface of the outer cylindrical portion 101 is less prone to harboring dirt and grime, and the outer cylindrical portion 101 will not get moldy and smelly.

In this embodiment, the structural parts of the cleaning member 10 when in contact with the floor are provided and at least a part of the outer cylindrical portion 101 close to the floor and the deformation portion 103 close to the floor are deformed when the outer cylindrical portion 101 is subjected to a pressure. The part of the outer cylindrical portion 101 close to the floor or in contact with the floor is deformed mainly towards the deformation zone 104 due to the pressure. At the same time, the deformation portion 103 corresponding to the part of the outer cylindrical portion 101 close to the floor or in contact with the floor is also deformed due to the pressure. In this state, a part of the outer surface of the outer cylindrical portion 101 is deformed towards the inner cylindrical portion 102 and the deformation zone 104, and the deformation portion 103 is deformed towards the deformation zone 104. The part deformed on the outer surface of the outer cylindrical portion 101 is configured to be the dirt accommodating space 105 having the concave structure, and the part deformed on the deformation portion 103 drives the part deformed on the outer cylindrical portion 101 to be deformed synchronously, to form the concave structure on the outer cylindrical portion 101, that is, forming the dirt accommodating space 105 on the outer cylindrical portion 101. In this case, the dirt accommodating space 105 may accommodate garbage and dirty water from the floor and carry and transfer them during the rotating or rolling movement of the cleaning member 10.

In the present embodiment, for the structural parts of the cleaning member 10, each of the deformation portion 103 and the outer cylindrical portion 101 is provided to be an elastic and restorable structure. Mainly, the flexible and deformable structures of the deformation portion 103 and the outer cylindrical portion 101 allow the outer cylindrical portion 101 and the deformation portion 103 to be elastically restore during or after the deformation to restore to the state before deformation, so that when the pressure applied on the outer cylindrical portion 101 is removed, the deformation portion 103 is restored by the deformation, the deformed part on the outer cylindrical portion 101 is synchronously restored by the deformation, and the dirt accommodating space having the concave structure 105 is deformed into the continuous surface structure. When the outer cylindrical portion 101 of the cleaning member 10 is in contact with the floor and is subjected to the pressure, the part of the outer surface of the outer cylindrical portion 101 contacting the floor is deformed to form a concave structure towards the deformation zone 104, and at the same time, the deformation portion 103 is also deformed towards the deformation zone 104 to synchronize the deformation of the deformed portion of the outer cylindrical portion 101. When the cleaning member 10 is removed from the floor and is not subjected to a pressure, the dirt accommodating space 105 having the concave structure undergoes elastic restoration deformation to switch to a continuous surface structure due to the absence of the pressure, and at the same time, the deformation portion 103 also undergoes elastic restoration deformation to form a connection between the outer cylindrical portion 101 and the inner cylindrical portion 102 and to provide support. It can be understood that when the outer cylindrical portion 101 contacts the floor and is subjected to the pressure, the part of the outer surface of the outer cylindrical portion 101 contacting the floor is deformed and switched from a continuous surface structure to a concave structure. In this case, the concave structure is the dirt accommodating space 105. When the outer cylindrical portion 101 is removed from the floor and is not subjected to a pressure, the dirt accommodating space 105 on the outer surface of the outer cylindrical portion 101 undergoes elastic restoration to deform and switch to a continuous surface structure, to realize the elastic restoration effect of the deformation portion 103 and the outer cylindrical portion 101.

Through the elastic restoration effect of the outer cylindrical portion 101 and the deformation portion, the outer surface of the outer cylindrical portion 101 constitutes a complete continuous surface structure when the outer cylindrical portion 101 and the deformation portion 103 are not deformed. The continuous surface structure of the outer cylindrical portion 101 can be effectively cleaned. The outer cylindrical portion 101 is less prone to harboring dirt and grime and is less prone to getting moldy and smelly. When the outer cylindrical portion 101 is deformed to form the dirt accommodating space having the concave structure 105, it is possible to effectively transfer garbage and sewage, realizing an effective floor cleaning effect, and whereby effectively cleaning the floor.

For the structural parts of the deformation portion 103, the deformation portion 103 includes an inner end portion 1031 and an outer end portion 1032. The inner end portion 1031 is configured to be connected to the inner cylindrical portion 102, and the outer end portion 1032 is configured to be connected to the outer cylindrical portion 101. The deformation portion 103 makes the outer cylindrical portion 101 and the inner cylindrical portion 102 spaced apart from each other. The deformation portion 103 connects the outer cylindrical portion 101 with the inner cylindrical portion 102, so that the outer cylindrical portion 101 is located in an outer annular zone, the inner cylindrical portion 102 is located in an inner annular zone, and the deformation portion 103 is located in an area between the outer annular zone and the inner annular zone. The deformation portion 103 acts as a connection and support structure for the outer cylindrical portion 101. The deformation portion 103 may also deform itself, and may drive the outer cylindrical portion 101 to be deformed synchronously. When the outer cylindrical portion 101 is in contact with the floor and is subjected to a pressure, the pressure will be transmitted to the deformation portion 103 through the outer cylindrical portion 101. Under the pressure, a part of the outer cylindrical portion 101 is deformed to form the dirt accommodating space 105, and the deformation portion 103 is also deformed to provide a deformation guide for the outer cylindrical portion 101, to enable both the outer cylindrical portion 101 and the deformation portion 103 to be deformed.

In the present embodiment, for the structural parts of the cleaning member 10, the number of the deformation portions 103 is provided to be multiple, and the multiple deformation portions 103 are spaced apart in the rotating or rolling direction. The multiple deformation portions 103 connect the inner cylindrical portion 102 with the outer cylindrical portion 101 at different positions. The deformation zone 104 is formed between every two adjacent deformation portions 103. The multiple deformation zones 104 are spaced apart in the rotating or rolling direction. The deformation zone 104 is provided to be a hollow or through structure in the axial direction of the cleaning member 10. The cleaning member 10 consisting of the multiple deformation portions 103 and the multiple deformation zones 104 allows a single dirt accommodating space 105 to be formed in a single deformation zone 104. During the outer surface of the outer cylindrical portion 101 contacts the floor and is subjected to pressure and the cleaning member 10 performs the rotating or rolling movement, as the cleaning member 10 rotates or rolls, different parts of the outer surface of the outer cylindrical portion 101 contact the floor and are subjected the pressure sequentially. In this case, the dirt accommodating space 105 having a concave structure may be formed at a position on the outer cylindrical portion 101 corresponding to a single deformation zone 104, and the dirt accommodating spaces 105 having the concave structures may be formed at positions on the outer cylindrical portion 101 corresponding to the multiple deformation zones 104, to enable the same part of the outer surface of the outer cylindrical portion 101 to be switched between the dirt accommodating space 105 having the concave structure and the continuous surface structure. In this way, any part of the outer cylindrical portion 101 can have a continuous surface structure for effective cleaning, whereby effectively cleaning the outer surface of the outer cylindrical portion 101 thoroughly.

In the present embodiment, the hollow or through structure of the deformation zone 104 allows the deformation zone 104 to effectively correspond to the dirt accommodating space 105 on the outer cylindrical portion 101, and allows the dirt accommodating space 105 to be effectively rebounded and restored so that the dirt accommodating space 105 is deformed from the concave structure to the continuous surface structure on the outer surface of the outer cylindrical portion 101. In this way, any part on the outer cylindrical portion 101 is not always the dirt accommodating space 105 having the concave structure, but continuously switches between the dirt accommodating space 105 having the concave structure and the continuous surface structure, to allow any part on the outer cylindrical portion 101 to be cleaned while it is in the continuous surface structure, and also allowing any part on the outer cylindrical portion 101 to function as the dirt accommodating space 105 having the concave structure, to carry, transfer and collect garbage and dirty water.

In the present embodiment, in order to further improve the effect of the deformation portion 103 in driving the outer cylindrical portion 101 to deform and improve the effect of the formation of the dirt accommodating space 105 having the concave structure, the cleaning member 10 is provided to perform the rotating or rolling movement in the rotating or rolling direction, namely a direction A, the deformation portion 103 is configured as a structure that extends from the inner end portion 1031 towards the outer end portion 1032, with an extended structure of the deformation portion 103 being provided to be an inclined structure. The extended structure of the deformation portion 103 makes the inner cylindrical portion 102 and the outer cylindrical portion 101 spaced apart and connected through the deformation portion 103. The deformation portion is provided with an inclined structure in an extending direction, which enables the outer cylindrical portion 101 to be deformed easily relative to the deforming portion 103, and enables the deforming portion 103 to be deformed easily relative to the inner cylindrical portion 102. Further, the deforming portion 103 may also drive a part of the outer cylindrical portion 101 to be deformed more effectively, facilitating the formation of the dirt accommodating space 105 on the outer cylindrical portion 101. When the outer cylindrical portion 101 comes into contact with the floor and is subjected to a pressure, the deformation portion 103 having the inclined structure provides exactly an appropriate deformation under the action of the pressure as compared with the deformation portion 103 having a perpendicular structure, so that the deformation portion 103 is effectively deformed along its inclined direction, it improve the effect of the deformation portion 103 in driving the outer cylindrical portion 101 to be deformed, and improving the effect of the formation of the dirt accommodating space 105.

The deformation portion 103 is provided to be not perpendicular to the outer cylindrical portion 101 or the inner cylindrical portion 102 in the extending direction. This is because a perpendicular structure would deteriorate the deformation performance of the deformation portion 103 and the outer cylindrical portion 101 relative to the inner cylindrical portion 102. That is, under the same structure, the deformation portion 103 having the perpendicular structure exhibits relatively inferior deformation performance compared to the deformation portion 103 having the inclined structure, resulting a poorer deformation performance of the dirt accommodating space 105 on the outer cylindrical portion 101, and less effective deformation performance of the deformation portion 103 itself, which is undesirable for improving the floor cleaning effect.

With respect to the inclined structure of the deformation portion 103, the deformation portion 103 is provided to be a straight inclined structure or an arcuate inclined structure in a direction opposite to the direction A from the inner end portion 1031 towards the outer end portion 1032. In this way, when the cleaning member 10 is rotated or rolled, the deformation portion 103 may be effectively deformed along its inclined direction. When the outer cylindrical portion 101 is subjected to a pressure, the pressure causes the deformation portion 103 to deform along the inclined direction, so that the deformation portion 103 itself has a smaller blocking force, and can be deformed easily along the inclined direction, it improve the effect of formation of the dirt accommodating space 105 on the outer cylindrical portion 101. Further, the inclined structure is provided with an arrangement to which a straight structure or an arcuate structure may correspond.

When the deformation portion 103 is provided with an arcuate inclined structure, the deformation portion 103 is provided to be curved in the direction A. In this way, an outer surface of the deformation portion 103 facing the direction A is convex in the direction A, and an outer surface of the deformation portion 103 facing a direction opposite to the direction A is concave in the direction A, to form an arcuate structure to better guide the deformation of the deformation portion 103, to improve the effect of the deformation portion 103 in driving a part of the outer cylindrical portion 101 to deform and form the dirt accommodating space 105.

When the deformation portion 103 has the inclined structure, an angle Q formed between the deformation portion 103 and the inner cylindrical portion 102 in the direction opposite to the direction A is greater than or equal to 30 degrees and less than or equal to 75 degrees. The angle Q generally refers to an included angle formed between the outer surface of the deformation portion 103 in the direction opposite to the direction A and the outer surface of the inner cylindrical portion 102, specifically the tangent of the outer surface of the inner cylindrical portion 102. When the deformation portion 103 has an arcuate inclined structure, the angle Q is mainly formed by the tangent of the outer surface of the deformation portion 103 in the direction opposite to the direction A and the tangent of the outer surface of the inner cylindrical portion 102. Within the angle range described above, the deformation portion 103 may deform more effectively along the inclined direction, so that the dirt accommodating space 105 may be easily formed on the outer cylindrical portion 101.

In one embodiment, the angle Q is provided to be greater than or equal to 45 degrees and less than or equal to 60 degrees. In this case, the effect of deformation of the deformation portion 103 along the inclined direction may be improved.

In one embodiment, the angle Q is provided to be greater than or equal to 50 degrees and less than or equal to 55 degrees. In this case, the effect of deformation of the deformation portion 103 along the inclined direction may be further improved.

The direction opposite to the direction A may be defined as direction B. One of the directions A and the direction B is clockwise, and the other is counterclockwise, which may be correspondingly determined depending on the requirements of the rotating or rolling structure of the cleaning member 10.

In the present embodiment, with respect to the structural parts of the cleaning member 10 for cleaning the floor, when the cleaning member 10 rotates or rolls on the floor and is subjected to a pressure, the pressure applied on the cleaning member 10 primarily comes from the cleaning apparatus 2 or the user. That is, when the cleaning assembly 1 is mounted on the cleaning apparatus 2 and the cleaning assembly 1 is placed on the floor, the cleaning member 10 is subjected to a pressure from a body of the cleaning apparatus 2 and a pressure applied by the user to the body of the cleaning apparatus 2. Under the action of the pressure, the multiple deformation portions 103 are deformed in sequence along the rotating or rolling direction and multiple dirt accommodating spaces 105 are formed in sequence. The multiple dirt accommodating spaces 105 have concave structures correspondingly towards the multiple deformation zones 104 in sequence for transferring solid matter or a mixture of solid matter and liquid in the rotating or rolling direction. In one embodiment, during the rotating or rolling movement of the cleaning member 10, different parts of the outer surface of the outer cylindrical portion 101 come into contact with the floor in sequence, forming the dirt accommodating spaces 105 having the concave structures at different parts of the outer surface of the outer cylindrical portion 101, so that multiple dirt accommodating spaces 105 are formed in sequence in the rotating or rolling direction to clean the floor. Different parts of the outer surface of the outer cylindrical portion 101 form a continuous surface structure, and the multiple dirt accommodating spaces 105 formed in sequence are deformed towards the multiple deformation zones 104 in sequence to form concave structures for carrying and transferring the garbage and dirty water on the floor, so that the dirt accommodating spaces 105 are continuously formed during the rotating or rolling movement of the cleaning member 10, thus continuously carrying and transferring the garbage or a mixture of garbage and dirty water on the floor.

It can be seen that when the cleaning member 10 in the present embodiment is not in contact with the floor, the outer surface of the outer cylindrical portion 101 presents a continuous surface structure or a continuous smooth surface structure. In this case, the outer cylindrical portion 101 does not harbor dirt and grime and can be easily washed clean. When the cleaning member 10 is in contact with the floor, the dirt accommodating space 105 having the concave structure is formed in an area of the outer surface of the outer cylindrical portion 101 contacting the floor. During the rotating or rolling movement of the outer cylindrical portion 101, the dirt accommodating spaces 105 are continuously formed at different parts, enabling the dirt accommodating spaces 105 to transfer garbage and dirty water. An area of the outer cylindrical portion 101 not in contact with the floor maintains a continuous surface structure or a continuous smooth surface structure, whereby effectively cleaning the dirty water and garbage on the outer surface of the outer cylindrical portion 101.

In the present embodiment, in order to improve the effect of the deformation portion 103 in driving the outer cylindrical portion 101 to perform stable deformation, and to improve the effect of deformation of the dirt accommodating space 105 on the outer cylindrical portion 101, the deformation portion 103 is provided to have a length L greater than one-fifth of an outer diameter D1 of the outer cylindrical portion 101. In this way, within the range of the outer diameter D1 of the outer cylindrical portion 101, the deformation portion 103 may have a desirable length L, so that the deformation portion 103 may be effectively deformed, and at the same time, a part of the outer cylindrical portion 101 may be deformed easily along the deformation portion 103, to effectively form the dirt accommodating space 105.

In the present embodiment, in order to improve the effect of the deformation portion 103 in driving the outer cylindrical portion 101 to perform stable deformation, and to improve the effect of deformation of the dirt accommodating space 105 on the outer cylindrical portion 101, the deformation portion 103 is provided to have a length L greater than one-fifth of an outer diameter D2 of the inner cylindrical portion 102. In this way, within the range of the outer diameter D2 of the inner cylindrical portion 102, the deformation portion 103 may have a desirable length L so that the deformation portion 103 may be effectively deformed, specifically deformed easily relative to the inner cylindrical portion 102, and at the same time, a part of the outer cylindrical portion 101 may be deformed easily along the deformation portion 103, to effectively form dirt accommodating space 105.

In the present embodiment, in order to improve the effect of the deformation portion 103 in driving the outer cylindrical portion 101 to perform stable deformation, and to improve the effect of deformation of the dirt accommodating space 105 on the outer cylindrical portion 101, a perpendicular distance H of the deformation portion 103 formed between the outer cylindrical portion 101 and the inner cylindrical portion 102 is provided to be greater than or equal to 5 mm. In this way, the deformation portion 103 may effectively makes the inner cylindrical portion 102 and the outer cylindrical portion 101 spaced apart, and effectively delimits the deformation zone 104, so that the dirt accommodating space 105 may easily form a concave structure towards the deformation zone 104. Additionally, the deformation portion 103 may be deformed easily relative to the inner cylindrical portion 102, and a part of the outer cylindrical portion 101 can be deformed easily along the deformation portion 103, to effectively form the dirt accommodating space 105.

In the present embodiment, for the structural parts of the deformation zone 104, a minimum spatial distance of the deformation zone 104 between two adjacent deformation portions 103 in the rotating or rolling direction is provided to be greater than or equal to twice the perpendicular distance H of the deformation portions 103 formed between the outer cylindrical portion 101 and the inner cylindrical portion 102. In this way, the deformation zone 104 has a more appropriate spatial distance in the rotating or rolling direction, allowing the deformation portion 103 and the outer cylindrical portion 101 to deform more easily towards the deformation zone 104. Further, the formed concave structure of the dirt accommodating space 105 in the rotating or rolling direction has a more appropriate size, and the issues of the concave structure being too small to transfer relatively large garbage can be avoided. Further, the perpendicular distance H of the deformation portion 103 enables the deformation zone 104 to have a larger spatial distance for a part of the outer cylindrical portion 101 to deform towards the deformation zone 104, so that the concave structure of the dirt accommodating space 105 may be formed stably, and the effect of deformation of the outer cylindrical portion 101 and the deformation portion 103 towards the deformation zone 104 may be improved, it improve the floor cleaning effect.

In the present embodiment, a thickness H1 of the outer cylindrical portion 101 is provided to be greater than or equal to 0.5 mm and less than or equal to 1.5 mm, so that within the thickness range, the outer cylindrical portion 101 may be effectively deformed and the dirt accommodating space 105 can be effectively formed. Further, the outer cylindrical portion 101 has a flexible structure with a higher toughness, making it less prone to being damaged by friction. The flexible structure of the outer cylindrical portion 101 avoids the issue of having excessive hardness, so that the dirt accommodating space 105 may be effectively formed, and the concave structure of the dirt accommodating space 105 may effectively carry and transfer the dirty water and garbage, to improve the floor cleaning effect.

In one embodiment, in the present embodiment, the thickness H1 of the outer cylindrical portion 101 is provided to be greater than or equal to 0.8 mm and less than or equal to 1.2 mm. In this way, the outer cylindrical portion 101 has higher flexibility for deformation, which facilitates the formation of the dirt accommodating space 105 having the concave structure on the outer cylindrical portion 101, to effectively improve the effect of the outer cylindrical portion 101 in transferring and collecting the garbage and dirty water, and improving the floor cleaning effect of the outer cylindrical portion 101.

In one embodiment, the thickness H1 of the outer cylindrical portion 101 is provided to be greater than or equal to 0.9 mm and less than or equal to Imm. In this case, the outer cylindrical portion 101 not only possesses better flexibility for deformation but also exhibits better toughness, thus the outer cylindrical portion 101 has a relatively better effect of deformation and relatively longer service life.

In the present embodiment, in order to further improve the effect of deformation of the outer cylindrical portion 101 for better formation of the dirt accommodating space 105 having the concave structure, a thickness H2 of the deformation portion 103 is provided to be greater than or equal to the thickness H1 of the outer cylindrical portion 101, so that the outer cylindrical portion 101 has a better flexibility compared to the deformation portion 103. In this way, the outer cylindrical portion 101 may be deformed easily relative to the deformation portion 103, and a part of the outer cylindrical portion 101 may be deformed easily towards the deformation zone 104 to form the dirt accommodating space 105, so that the deformation portion 103 drives the outer cylindrical portion 101 to be deformed easily towards the deformation zone 104, facilitating the formation of the dirt accommodating space 105 having the concave structure on the outer cylindrical portion 101, to improve the effect of the cleaning member 10 in transferring the garbage and dirty water.

In the present embodiment, in order to further improve the effect of the outer cylindrical portion 101 being deformed to easily form the dirt accommodating space 105 having the concave structure, an average thickness H0 of the deformation portion 103 is provided to be greater than or equal to the thickness H1 of the outer cylindrical portion 101. The deformation portion 103 may be provided to have an irregular thickness, and may have a thickness gradually decreasing in the extending direction. In this way, the outer cylindrical portion 101 has a better flexibility relative to the deformation portion 103, so that the outer cylindrical portion 101 may be deformed easily relative to the deformation portion 103. Further, a part of the outer cylindrical portion 101 may be deformed easily towards the deformation zone 104 to form the dirt accommodating space 105, so that the deformation portion 103 drives the outer cylindrical portion 101 to deform easily towards the deformation zone 104, facilitating the formation of the dirt accommodating space 105 having the concave structure on the outer cylindrical portion 101, it improve the effect of the cleaning member 10 in driving and transferring the garbage and dirty water.

In one embodiment, the deformation portion 103 is provided to gradually decrease in thickness from the inner end portion 1031 to the outer end portion 1032, so that the outer end portion 1032 of the deformation portion 103 has a smaller thickness, providing a better flexibility and deformation capability, to improve the effect of deformation of the outer cylindrical portion 101 relative to the deformation portion 103. In this way, the outer cylindrical portion 101 may be deformed more easily relative to the deformation portion 103, and a part of the outer cylindrical portion 101 may be deformed more easily towards the deformation zone 104 to form the dirt accommodating space 105, so that the deformation portion 103 drives the outer cylindrical portion 101 to be deformed more easily towards the deformation zone 104, facilitating the formation of the dirt accommodating space 105 having the concave structure on the outer cylindrical portion 101, to improve the effect of the cleaning member 10 in driving and transferring garbage and dirty water.

In the present embodiment, in order to further improve the wear resistance and reliability of the cleaning member 10 during the rotating or rolling movement, a thickened portion is provided at a position where the outer surface of the deformation portion 103 in the rotating or rolling direction intersects the inner surface of the outer cylindrical portion 101, and a thickness of the thickened portion is provided to be greater than the thickness H1 of the outer cylindrical portion 101 and greater than the thickness H2 of the deformation portion 103. The thickened portion is mainly formed by thickening a part at a position where the outer surface of the deformation portion 103 in the rotating or rolling direction intersects the inner surface of the outer cylindrical portion 101 towards the deformation zone 104, so that a larger thickness is provided at the position where the outer surface of the deformation portion 103 in the rotating or rolling direction intersects the inner surface of the outer cylindrical portion 101. In this way, during the rotating or rolling movement of the cleaning member 10, even though a deeper dirt accommodating space 105 is formed, the part at the position where the outer surface of the deformation portion 103 in the rotating or rolling direction intersects the inner surface of the outer cylindrical portion 101 is less prone to being worn and damaged, which prevents the outer cylindrical portion 101 from being separated from the deformation portion 103 due to damage caused by friction with the floor during the rotating or rolling movement, to effectively improve the wear resistance and reliability of the cleaning member 10 and prolonging the service life of the cleaning member 10.

In the present embodiment, in order to further improve the wear resistance and reliability of the cleaning assembly 1 during the rotating or rolling movement, the dirt accommodating space 105 having the concave structure is provided with thickened portions at both ends in the rotating or rolling direction, and the thickness of each of the thickened portions is greater than the thickness of part of the concave structure of the dirt accommodating space 105 other than the thickened portions. During the rotating or rolling movement of the cleaning member 10, the dirt accommodating space 105 having the concave structure is formed on the outer cylindrical portion 101. In this case, the dirt accommodating space 105 mainly forms with bending structures at both ends in the rotating or rolling direction. The bending structure contacts the floor at one end, and the bending structure is recessed toward the deformation zone 104 at the other end. In this case, the bending structures on both sides of the dirt accommodating space 105 correspond to the two ends of the dirt accommodating space 105 in the rotating or rolling direction. When the two ends of the dirt accommodating space 105 comes into contact with the floor, friction may be generated between the two ends of the dirt accommodating space 105 and the floor. During the continuous rotating or rolling movement of the cleaning member 10, the two ends of the dirt accommodating space 105 come into contact with the floor continuously and intermittently, resulting in friction and making them prone to wear and damage. By providing the thickened portions, the two ends of the dirt accommodating space 105 each has a thickness greater than the thickness of part of the concave structure of the dirt accommodating space 105 other than the thickened portions, to effectively improve the wear resistance of the two ends of the dirt accommodating space 105, preventing the dirt accommodating space 105 from being damaged due to friction with the floor during the rotating or rolling movement, effectively improving the wear resistance and reliability of the cleaning member 10, improving the stability of the dirt accommodating space 105 in accommodating dirty water and garbage, and prolonging the service life of the cleaning member 10.

In the present embodiment, in order to further improve the effective deformation of the outer cylindrical portion 101 and the deformation portion 103 relative to the inner cylindrical portion 102, a thickness H3 of the inner cylindrical portion 102 is provided to be greater than the thickness H2 of the deformation portion 103. The deformation portion 103 having a smaller thickness relative to the inner cylindrical portion 102 allows the deformation portion 103 to be deformed easily relative to the inner cylindrical portion 102, so that the deformation portion 103 may drive the outer cylindrical portion 101 to be deformed easily toward the deformation zone 104, facilitating the formation of the dirt accommodating space 105 having the concave structure on the outer cylindrical portion 101, to improve the effect of the cleaning member 10 in driving and transferring the garbage and dirty water.

In the present embodiment, in order to further improve the effective deformation of the outer cylindrical portion 101 and the deformation portion 103 relative to the inner cylindrical portion 102, the deformation amount of the inner cylindrical portion 102 is provided to be smaller than that of the outer cylindrical portion 101 and smaller than that of the deformation portion 103. In this way, the outer cylindrical portion 101 and the deformation portion 103 each has a larger deformation amount relative to the inner cylindrical portion 102, which improves the effect of deformation of the outer cylindrical portion 101 and the deformation portion 103 relative to the inner cylindrical portion 102. Therefore, the deformation portion 103 drives the outer cylindrical portion 101 to be deformed easily towards the deformation zone 104, facilitating the formation of the dirt accommodating space 105 having the concave structure on the outer cylindrical portion 101, and it improve the effect of the cleaning member 10 in driving and transferring garbage and dirty water.

In the present embodiment, in order to further effectively improve the stability of the rotating or rolling movement and the ease of thorough cleaning of the cleaning member 10, at least the outer cylindrical portion 101 and the deformation portion 103 are configured to be composed of a hydrophobic material, so that the outer cylindrical portion 101 and the deformation portion 103 do not absorb liquid. The use of the hydrophobic material for the outer cylindrical portion 101 and the deformation portion 103 prevents the outer cylindrical portion 101 and the deformation portion 103 from absorbing the dirty water and adhering to garbage, making it easy to clean the outer cylindrical portion 101 with clean water. Further, the weight of the cleaning member 10 does not increase excessively during the cleaning of the floor, which ensures a higher stability in the rotating or rolling movement of the cleaning member 10. The hydrophobic material allows the cleaning member 10 to be easily dried in a natural state, without providing a drying or air-drying structure for the drying process, making the cleaning member 10 less prone to getting moldy and smelly.

In one embodiment, the outer cylindrical portion 101, the deformation portion 103 and the inner cylindrical portion 102 are all composed of a hydrophobic material, so that the cleaning member 10 as a whole has a structure that does not absorb liquid.

The hydrophobic material may be a silicone material, a silicone rubber material or the like.

In the present embodiment, in order to further improve the floor cleaning effect of the cleaning member 10, at least the outer cylindrical portion 101 is made of a uniform mixture of two materials with different hardness, so that at least a part of the outer surface of the outer cylindrical portion 101 has a frosted structure or a granular structure. The uniform mixing of the two materials not only provides the cleaning member 10 with good flexibility for deformation, but also creates a certain frosted or granular effect on the outer surface of the outer cylindrical portion 101, to increase the roughness of the outer surface of the outer cylindrical portion 101. In this way, the outer surface of the outer cylindrical portion 101 may conduct better frictional traction when contacting the floor, which improves the floor cleaning effect of the cleaning member 10 and facilitates the effective removal of stubborn dirt from the floor.

By providing the two materials with different hardness, one of the materials allows the cleaning member 10 to maintain a higher softness, and the other of the materials allows the outer surface of the outer cylindrical portion 101 on the cleaning member 10 to have a certain roughness, which can effectively improve the floor cleaning effect of the cleaning member 10.

With respect to the material composition of the cleaning member 10 in the present embodiment, at least the outer cylindrical portion 101 is made of silicone rubber material and the hardness of the silicone rubber material is set to be 35 to 55 Shore A. The silicone rubber material allows the outer cylindrical portion 101 to have better softness and higher toughness and wear resistance, which can effectively improve the effect of deformation of the outer cylindrical portion 101 and prolonging the service life of the outer cylindrical portion 101, and can effectively meet the beneficial effects achieved by the cleaning member 10 in the present embodiment.

In one embodiment, the outer cylindrical portion 101 is made of silicone rubber material and the hardness of the silicone rubber material is set to be 45 to 50 Shore A. In this case, the outer cylindrical portion 101 has a better softness and deformation effect and a higher wear resistance.

In the present embodiment, the outer cylindrical portion 101, the deformation portion 103 and the inner cylindrical portion 102 are all made of silicone rubber material and the hardness of the silicone rubber material is set to be 35 to 55 Shore A, so that the overall structure of the cleaning member 10 has a better softness and deformation effect and a higher toughness.

It can be seen that the cleaning member 10 in the present embodiment is provided with the outer cylindrical portion 101, the inner cylindrical portion 102 and the deformation portion 103. The outer cylindrical portion 101 is a continuous surface structure when not in contact with the floor, that is, configured to be a continuous surface structure. The continuous surface structure is less prone to harboring dirt and grime, and less prone to adhering to or accumulating garbage or dirty water. When the outer cylindrical portion 101 comes into contact with the floor, the dirt accommodating space 105 having the concave structure is formed by the deformation. The dirt accommodating space 105 is used to accommodate and transfer the garbage and dirty water, so that the garbage and dirty water on the floor can be transferred and collected.

In the present embodiment, for the structural parts of the cleaning assembly 1, a support cylinder is further provided. The support cylinder is positioned in the inner cylindrical portion 102 to enable the inner cylindrical portion 102 to be sleeved on the outer surface of the support cylinder through the inner surface of the inner cylindrical portion 102, so that a connected mounting structure is formed between the inner cylindrical portion 102 and the support cylinder. When the cleaning assembly 1 performs the rotating or rolling movement, the support cylinder performs a rotating or rolling movement, so that the support cylinder drives the inner cylindrical portion 102, the outer cylindrical portion 101 and the deformation portion 103 to synchronously perform a rotating or rolling movement for transportation, allowing the cleaning member 10 to clean the floor during its rotating or rolling movement.

The cleaning assembly 1 in the present embodiment is mainly configured to be mounted on the cleaning apparatus 2 to clean the floor. When the cleaning apparatus 2 is activated, the cleaning assembly 1 is put into operation. In one embodiment, the cleaning member 10 performs the rotating or rolling movement to clean the floor. During this process, the outer cylindrical portion 101 contacts the floor to carry and transfer the garbage or the mixture of garbage and dirty water on the floor, to collect the garbage and dirty water.

The cleaning apparatus 2 in the present embodiment includes a machine body, which is placed on the floor and moves to clean the floor during the movement. The cleaning apparatus 2 further includes the cleaning assembly 1 as described above, which is configured to be detachably mounted in a cleaning chamber 201 on the machine body. When the cleaning assembly 1 performs the rotating or rolling movement, the cleaning assembly 1 may be configured to contact the floor for cleaning. The cleaning assembly 1 is mainly mounted in the cleaning chamber 201 on the machine body. The cleaning chamber 201 is configured to be open in a lower part and with a hollow structure. The cleaning assembly 1 is mainly detachably mounted in the cleaning chamber 201. Further, a driving member is provided on the machine body. The driving member operates to drive the cleaning member 10 to perform the rotating or rolling movement in the cleaning chamber 201, and the cleaning member 10, during its rotating or rolling movement, contacts the floor for cleaning.

The machine body is provided with a liquid supply box and a recycling box. The liquid supply box is mainly used for supplying liquid. In this case, the liquid is clean water. The clean water is supplied to the washing zone 1011 on the outer cylindrical portion 101 of the cleaning member 10 to flush and rinse the outer surface of the outer cylindrical portion 101. Since the washing zone 1011 on the outer cylindrical portion 101 is a continuous surface structure with no dirt accommodating space 105 formed, the continuous surface structure on the outer cylindrical portion 101 can be easily washed clean, and is less prone to harboring dirt and grime, whereby effectively washing the outer cylindrical portion 101 clean. Further, during the washing process, the clean water and the dirty water formed during the cleaning process flow along the continuous surface structure on the outer surface of the outer cylindrical portion 101 and flow downward to the dirt accommodating space 105. The dirt accommodating space 105 accommodates the garbage and dirty water and then carries and transfers them during the rotating or rolling movement of the cleaning member 10, to collect the garbage and dirty water. The recycling box is mainly used to collect dirty water and garbage. The dirty water and garbage carried and transferred by the cleaning member 10 may enter the recycling box for collection under the action of an external force. The user only needs to regularly maintain and clean the recycling box.

In the present embodiment, the machine body is further provided with a liquid supply part connected to the liquid supply box. The liquid supply part is configured to supply liquid to the cleaning member 10. The liquid supply part is mainly used to supply and transfer the clean water in the liquid supply box to the cleaning member 10. In one embodiment, the liquid supply part mainly transfers the liquid, i.e., the clean water, to the washing zone 1011 on the outer cylindrical portion 101, so that the clean water at the washing zone 1011 of the outer cylindrical portion 101 can effectively flush or spray the continuous surface structure on the outer cylindrical portion 101. Since the washing zone 1011 is on the continuous surface structure of the outer cylindrical portion 101, the outer cylindrical portion 101 can be easily washed clean, which effectively improves the ease of washing the cleaning member 10 clean and address the issue that the cleaning member 10 is prone to harboring dirt and grime as well as get moldy and smelly.

In the present embodiment, for the recycling structures for the dirty water and garbage, the machine body is further provided with a recycling part connected to the recycling box. The recycling part is configured to be connected to the cleaning chamber 201. The recycling part is configured to allow the solid matter or the mixture of solid matter and liquid carried and transferred by the dirt accommodating space 105 to flow through and be collected in the recycling box. The recycling part may be configured to be a pipeline or channel. The recycling part connects the cleaning chamber 201 and the recycling box, so that the solid matter, i.e. garbage, and liquid, i.e. a mixture of dirty water and garbage, may enter the recycling part from the cleaning chamber 201 during the process of being carried and transferred by the cleaning member 10, and enter the recycling box through the recycling part, to collect the garbage and dirty water.

In the present embodiment, the machine body is further provided with a power member. The power member is configured to provide power to transfer the solid matter or the mixture of solid matter and liquid to the recycling box for collection. The power member may be provided as a pump, such as a vacuum pump or a liquid suction pump. In one embodiment, the power member may be provided as a structure that can generate airflow suction, such as a suction pump or a fan with high suction force. The power member may be provided to be connected to the recycling box, so that the power member, when activated, provides power to transfer garbage and dirty water, and the cleaning member 10 may further transfer garbage and dirty water under the power generated by the power member during transferring garbage and dirty water, and then transfer the dirty water and garbage to the recycling box.

In the present embodiment, the cleaning apparatus 2 may be provided as a self-moving structure, such as a mopping robot, a cleaning robot and a floor washing robot. The cleaning apparatus 2 may also be provided as a handheld structure, such as a handheld mopping machine and a handheld floor scrubber. Both the self-moving structure and the handheld structure allow the mounting of the cleaning assembly 1 on the cleaning apparatus 2 to clean the floor upon contact.

In one embodiment, the cleaning apparatus 2 in the present embodiment is configured to be a floor scrubber, such as a handheld floor scrubber, which supplies clean water to the cleaning member 10 and transfers dirty water and garbage through the cleaning member 10 for recycling and collection.

The working principle of the cleaning assembly 1 in the present embodiment is as follows. The cleaning assembly 1 is mainly provided with the cleaning member 10. The cleaning member 10 is mainly provided with the outer cylindrical portion 101, the inner cylindrical portion 102 and the deformation portion 103. The outer cylindrical portion 101 and the deformation portion 103 are of deformable structures. When the cleaning member 10 comes into contact with the floor and is subjected to a pressure, the outer cylindrical portion 101 and the deformation portion 103 may be deformed. When the cleaning member 10 performs the rotating or rolling movement on the floor, the dirt accommodating spaces 105 are formed in sequence in the rotating or rolling direction. The dirt accommodating space 105 each is a concave structure to carry and transfer solid matter or a mixture of solid matter and liquid on the floor, to collect garbage or a mixture of garbage and dirty water. When the cleaning member 10 is not in contact with the floor for cleaning, the outer cylindrical portion 101 is not in contact with the floor and is not subjected to pressure, so that the dirt accommodating space 105 is deformed and restored from the concave structure to a continuous surface structure or a continuous smooth surface. In this case, an effective washing effect for the cleaning member 10 can be achieved, meaning that the cleaning member 10 can be effectively washed clean. Further, the cleaning member 10 can effectively clean the floor. The cleaning assembly 1 is mainly mounted on the cleaning apparatus 2. The cleaning apparatus 2 is activated to clean the floor by the cleaning assembly 1.

The above embodiments are specific examples for implementing the present application, and in practical applications, various changes can be made in form and detail without departing from the spirit and scope of the present application, and all are within the scope of protection of the present application.

1. A cleaning assembly, comprising a cleaning member for contacting a floor to clean the floor, wherein
the cleaning member comprises an inner cylindrical portion and an outer cylindrical portion, a deformation portion is provided between the inner cylindrical portion and the outer cylindrical portion, and a deformation zone is provided on either side of the deformation portion;
at least the outer cylindrical portion and the deformation portion are flexible and deformable;
the outer cylindrical portion has an outer surface, which is configured to be in a continuous surface structure when the outer cylindrical portion is not in contact with the floor, and is configured to at least partially come into contact with the floor and to be recessed towards the deformation zone to form a dirt accommodating space having a concave structure when the outer cylindrical portion is pressed on the floor;
the dirt accommodating space has an opening, allowing the dirt accommodating space to open towards the floor, and
the dirt accommodating space is configured to carry and transfer solid matter or a mixture of solid matter and liquid on the floor when the cleaning member is rotated or rolled on the floor.

2. The cleaning assembly according to claim 1, wherein, when the cleaning member is placed on the floor and is rotated or rolled, a part of the outer cylindrical portion contacting the floor is recessed to form the dirt accommodating space having the concave structure, and a part of the outer cylindrical portion not in contact with the floor is in the continuous surface structure, and
when the cleaning member is continuously rotated or rolled, the concave structure and the continuous surface structure are alternately formed on at least a part of the outer surface of the outer cylindrical portion.

3. The cleaning assembly according to claim 2, wherein a structure for supplying liquid to the cleaning member is provided in such a way that a washing zone is located at the part of the outer cylindrical portion in the continuous surface structure so that liquid in the washing zone cleans the part of the outer cylindrical portion in the continuous surface structure, and is located above the dirt accommodating space so that the liquid flows downward along the part of the outer cylindrical portion in the continuous surface structure into the dirt accommodating space and is then carried and transferred by the dirt accommodating space.

4. The cleaning assembly according to claim 2, wherein, during the rotational or rolling movement of the cleaning member, a cross-sectional area of the dirt accommodating space is variable with change of pressure on the outer cylindrical portion or size of solid matter on the floor, so that the solid matter of different sizes can be wrapped in the dirt accommodating space for carrying and transferring.

5. The cleaning assembly according to claim 2, wherein the outer cylindrical portion is in a form of a cylinder, and when the outer cylindrical portion is not in contact with the floor, the outer surface of the outer cylindrical portion is a complete continuous smooth arc surface in the rotating or rolling direction and is a complete continuous smooth surface in an axial direction thereof.

6. The cleaning assembly according to claim 2, wherein at least a part of the outer cylindrical portion close to the floor and the deformation portion close to the floor are deformed when the outer cylindrical portion is pressed, so that the part of the outer surface of the outer cylindrical portion is deformed towards the inner cylindrical portion and the deformation zone, and the deformation portion is deformed towards the deformation zone.

7. The cleaning assembly according to claim 2, wherein each of the deformation portion and the outer cylindrical portion is elastically restorable so that, when a pressure applied to the outer cylindrical portion is removed, the deformation portion and the part of the outer cylindrical portion that are deformed are restored synchronously, and the dirt accommodating space having the concave structure is deformed into the continuous surface structure.

8. The cleaning assembly according to claim 1, wherein the deformation portion comprises an inner end portion and an outer end portion, the inner end portion is connected to the inner cylindrical portion, the outer end portion is connected to the outer cylindrical portion, and the deformation portion is configured to space the outer cylindrical portion and the inner cylindrical portion apart from each other.

9. The cleaning assembly according to claim 8, wherein there are a plurality of deformation portions, and the plurality of deformation portions are spaced apart in the rotating or rolling direction;
the deformation zone is formed between every two adjacent deformation portions, meaning that a plurality of deformation zones are spaced apart in the rotating or rolling direction, and each of the plurality of deformation zones is in a hollow or through structure in an axial direction of the cleaning member.

10. The cleaning assembly according to claim 9, wherein the rotating or rolling direction of the cleaning member is defined as a direction A, and the deformation portion extends obliquely from the inner end portion to the outer end portion.

11. The cleaning assembly according to claim 10, wherein the deformation portion extends in a direction opposite to the direction A from the inner end portion to the outer end portion in a straightly inclined structure or an arcuately inclined structure;
the deformation portion is curved in the direction A in case of the deformation portion in the arcuately inclined structure, or is at an angle Q from the inner cylindrical portion opposite to the direction A in case of the deformation portion in the inclined structure, the angle Q being greater than or equal to 30 degrees and less than or equal to 75 degrees.

12. The cleaning assembly according to claim 2, wherein a plurality of deformation portions are deformed in sequence along the rotating or rolling direction, wherein a plurality of dirt accommodating spaces are formed in sequence when the cleaning member is rotated or rolled on the floor and is subjected to a pressure, and the plurality of dirt accommodating spaces are correspondingly recessed towards a plurality of deformation zones in sequence, thereby transferring solid matter or the mixture of solid matter and liquid in the rotating or rolling direction.

13. The cleaning assembly according to claim 12, wherein a length L of the deformation portion is greater than one-fifth of an outer diameter D1 of the outer cylindrical portion, or the length L of the deformation portion is greater than one-fifth of an outer diameter D2 of the inner cylindrical portion; or
a perpendicular distance H of the deformation portion measured between the outer cylindrical portion and the inner cylindrical portion is greater than or equal to 5 mm.

14. The cleaning assembly according to claim 13, wherein a minimum spatial distance of the deformation zone between two adjacent deformation portions in the rotating or rolling direction is greater than or equal to twice the perpendicular distance H of the deformation portion measured between the outer cylindrical portion and the inner cylindrical portion.

15. The cleaning assembly according to claim 13, wherein a thickness H1 of the outer cylindrical portion is greater than or equal to 0.5 mm and less than or equal to 1.5 mm.

16. The cleaning assembly according to claim 15, wherein the thickness H1 of the outer cylindrical portion is greater than or equal to 0.8 mm and less than or equal to 1.2 mm.

17. The cleaning assembly according to claim 13, wherein a thickness H2 of the deformation portion is greater than or equal to a thickness H1 of the outer cylindrical portion; or
an average thickness H0 of the deformation portion is greater than or equal to the thickness H1 of the outer cylindrical portion; or
a thickened portion is provided at a position where the outer surface of the deformation portion defined in view of the rotating or rolling direction intersects an inner surface of the outer cylindrical portion, and a thickness of the thickened portion is greater than the thickness H1 of the outer cylindrical portion and greater than the thickness H2 of the deformation portion; or
the concave structure of the dirt accommodating space is provided with thickened portions at both ends in the rotating or rolling direction, and a thickness of each of the thickened portions is greater than a thickness of part of the concave structure of the dirt accommodating space other than the thickened portions.

18. The cleaning assembly according to claim 17, wherein a thickness H3 of the inner cylindrical portion is greater than the thickness H2 of the deformation portion, or a deformation amount of the inner cylindrical portion is smaller than that of the outer cylindrical portion and smaller than that of the deformation portion.

19. The cleaning assembly according to claim 18, wherein at least the outer cylindrical portion and the deformation portion are formed of a hydrophobic material, so that the outer cylindrical portion and the deformation portion do not absorb liquid; or
at least the outer cylindrical portion is made of a uniform mixture of two materials with different hardness, so that at least a part of the outer surface of the outer cylindrical portion has a frosted structure or a granular structure; or
at least the outer cylindrical portion is made of a silicone rubber material with the hardness ranging from 35 to 55 Shore A.

20. A cleaning apparatus, comprising a machine body and the cleaning assembly according to claim 1, wherein the cleaning assembly is detachably mounted in a cleaning chamber of the machine body, and is configured to contact the floor for cleaning when the cleaning assembly is rotated or rolled; and wherein
the machine body is provided with a liquid supply box and a recycling box;
the machine body is further provided with a liquid supply part connected to the liquid supply box, and the liquid supply part is configured to supply liquid to the cleaning member;
the machine body is further provided with a recycling part connected to the recycling box, and the recycling part is configured to allow solid matter or a mixture of solid matter and liquid carried and transferred by the dirt accommodating space to flow through and to be collected in the recycling box; and
the machine body is further provided with a power member, which is configured to provide power to transfer the solid matter or the mixture of solid matter and liquid to the recycling box for collection.
